(19) United States
(12) Patent Application Publication
(10) Pub. No.: US 2007/0033596 A1
(43) Pub. Date: Feb. 8, 2007

(54) Reconfigurable State Structure Based System Design for Embedded Multimedia System

(76) Inventors: Jason D. Kridner, Houston, TX (US); Charles E. McCallum, Dallas, TX (US); Prabindh Sundareson, MADURAI (IN)

Correspondence Address: TEXAS INSTRUMENTS INCORPORATED, P O BOX 655474, M/S 3999, DALLAS, TX, 75265, US

(21) Appl. No.: 11/279,691

(22) Filed: Apr. 13, 2006

Related U.S. Application Data
(60) Provisional application No. 60/671,931, filed on Apr. 14, 2005.

(51) Int. Cl. G06F 9/46

(52) U.S. Cl. 719/328

(57) ABSTRACT

A computer implemented method of multi-threaded data processing operation partitions each data processing module into at least five sub-modules including (1) receiving messages, (2) processing received messages, (3) getting resources for module function, (4) performing a core data processing operation of the module and (5) outputting resources generated. These modules are launched and retired as needed in a multi-threaded environment. A framework includes APIs for the module and each sub-module. The message and data handling sub-modules are optionally shared among modules.

### CLAIM OF PRIORITY

This application claims priority under 35 U.S.C. 119(e)(1) to U.S. Provisional Application No. 60/671,931 filed Apr. 14, 2005.

### TECHNICAL FIELD OF THE INVENTION

The technical field of this invention is program design tools for multi-threaded applications.

### BACKGROUND OF THE INVENTION

The needs of each multimedia system vary greatly, depending on the end product requirements. For example, the requirements for a Flash (a ROM, small form factor, medium cost chip) based devices are that of support for audio formats, and long playing times when working with a battery. But the requirements of a HDD (Hard Disk Device) based portable device are, support for movie playback, audio/speech encoding etc. With contrasting requirements, there is the added complexity of customers requiring different Operating Systems, processors having different hardware architectures etc. In this scenario, a flexible framework is needed that provides support for all these requirements and yet does not require large amounts of memory.

In many cases, multi-threaded system design is confused with a scalable architecture that can be used across multiple platforms, with multiple applications. A multi-threaded system design merely accommodates the need for each application module to compartmentalize its internal workings. Current frameworks lack the following 3 things:

1. Easy configurability for addition, removal and placement in another position;

2. Productivity enhancement during the development stages, such as scripting tools to speed development flow;

3. Low memory requirements of less than 2 kBytes.

There are many program development frameworks in the embedded system world. Due to the variety, there is no dominant framework. The framework gStreamer is used for multimedia development in Linux based systems.

Disadvantages of existing, embedded system designs include:

1. They do not offer a way to separate the input and output data transfers and message handling from the core application processing using that data. The data transfer and message handling is still mixed up with the application's functions. Thus it is difficult to quickly visualize the functioning of a module.

2. Common aspects of various threads with regard to data handling and message handling cannot be shared. For example, module1 could have a data handling mechanism for its input and output, which is similar to that of module2. In a typical development cycle the threads are coded by different designers and there is no sharing the common data handling mechanisms. Each thread invariably repeats similar code.

3. Many customers require system functionalities that emulate the way other multimedia platforms function. For example, customers familiar with the PC/Mac platforms look for plug and play capability in portable multimedia systems. This becomes quite complicated in the case of a typical multi-threaded design because each thread has its own method of processing data. This makes placing a new module in the middle of a processing chain complicated. The new module has to be able to cater to both the previous and the next module's data format. Hence, there is no equivalent to graphical connections like DirectX in Windows.

The frameworks found in the PC/Unix domains require a lot of memory because they use dynamic memory allocation. The code is not optimized for low memory embedded systems because PC/Unix systems do not have the constraints that n embedded system faces. On the other hand, the frameworks developed for embedded applications are generally too specific. This causes a loss in productivity every time a new application is developed.

### SUMMARY OF THE INVENTION

A computer implemented method of multi-threaded data processing operation partitions each data processing module into at least five sub-modules including (1) receiving messages, (2) processing received messages, (3) getting resources for module function, (4) performing a core data processing operation of the module and (5) outputting resources generated. These modules are launched and retired as needed in a multi-threaded environment. A framework includes APIs for the module and each sub-module. The message and data handling sub-modules are optionally shared among modules.

### BRIEF DESCRIPTION OF THE DRAWINGS

These and other aspects of this invention are illustrated in the drawings, in which:

FIG. 1 is a block diagram of an example digital audio system to which this invention is applicable;

FIG. 2 is a flow chart illustrating the data processing operations involved in time-scale modification employing the example digital audio system of FIG. 1;

FIG. 3 illustrates the application process interfaces (API's) of this invention; and

FIG. 4 illustrates the run-time operation 400 of this invention.

### DETAILED DESCRIPTION OF PREFERRED EMBODIMENTS

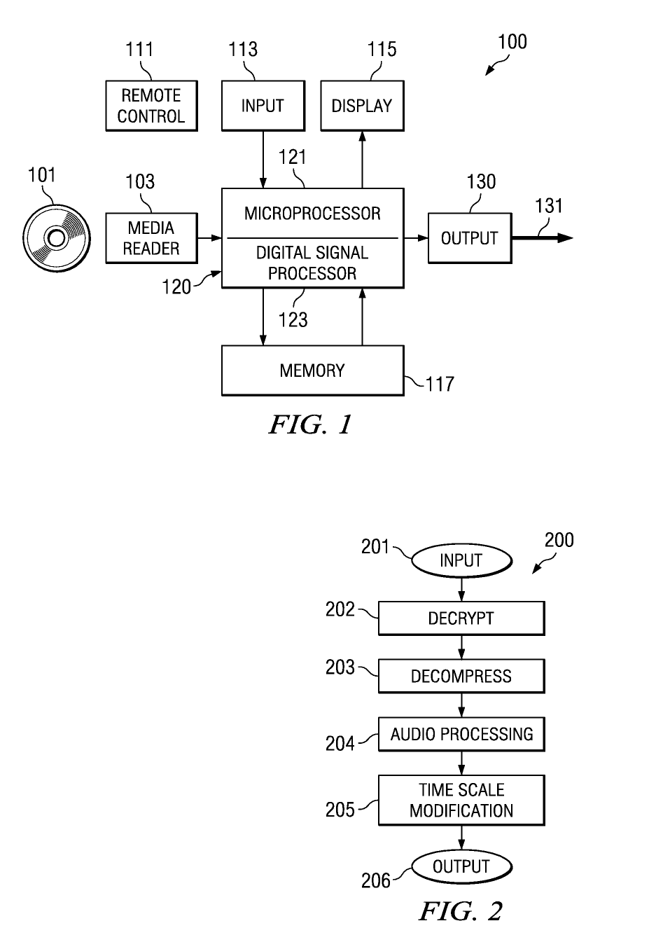

FIG. 1 is a block diagram illustrating an example digital audio system to which this invention is applicable. This example embodiment is a DVD player or DVD player/recorder which uses the time scale modification with fast forward or slow motion video to provide audio synchronized with the video in these modes.

System 100 receives digital data on media 101 via media reader 103. In the preferred embodiment media 101 is a DVD optical disk and media reader 103 is the corresponding disk reader. It is feasible to apply this technique to other media and corresponding reader such as audio CDs, removable magnetic disks (i.e. floppy disk), memory cards or similar devices. Media reader 103 delivers digital data corresponding to the desired audio to processor 120.

Processor 120 performs data processing operations required of system 100. Processor 120 may include two different processors, microprocessor 121 and digital signal processor 123. Microprocessor 121 is preferably employed for control functions such as data movement, responding to user input and generating user output. Digital signal processor 123 is preferably employed in data filtering and manipulation functions such as decryption, decoding and time scale modification. A Texas Instruments digital signal processor from the TMS320C5000 family is suitable for this invention.

Processor 120 is connected to several peripheral devices. Processor 120 receives user inputs via input device 113. Input device 113 can be a keypad device, a set of push buttons or a receiver for input signals from remote control 111. Input device 113 receives user inputs which control the operation of system 100. Processor 120 produces outputs via display 115. Display 115 may be a set of LCD (liquid crystal display) or LED (light emitting diode) indicators or an LCD display screen. Display 115 provides user feedback regarding the current operating condition of system 100 and may also be used to produce prompts for operator inputs. As an alternative for the case where system 100 is a DVD player or player/recorder connectable to a video display, system 100 may generate a display output using the attached video display. Memory 117 preferably stores programs for control of microprocessor 121 and digital signal processor 123, constants needed during operation and intermediate data being manipulated. Memory 117 can take many forms such as read only memory, volatile read/write memory, nonvolatile read/write memory or magnetic memory such as fixed or removable disks. Output 130 produces an output 131 of system 100. In the case of a DVD player or player/recorder, this output would be in the form of an audio/video signal such as a composite video signal, separate audio signals and video component signals and the like. In the case of music or audio data this output would generally take the form of an analog signal corresponding to the digital audio data for supply to headphones or an external audio amplifier and speaker system.

FIG. 2 is a flow chart illustrating process 200 including the major processing functions of system 100. Flow chart 200 begins with data input at input block 201. Data processing begins with an optional decryption function (block 202) to decode encrypted data delivered from media 101. Data encryption would typically be used for control of copying for theatrical movies delivered on DVD or compressed music data, for example. System 100 in conjunction with the data on media 101 determines if this is an authorized use and permits decryption if the use is authorized.

The next step is optional decompression (block 203). Data is often delivered in a compressed format to save memory space and transmit bandwidth. There are several motion picture data compression techniques proposed by the Motion Picture Experts Group (MPEG). These video compression standards typically include audio compression standards such as MPEG Layer 3 commonly known as MP3. There are other audio compression standards. The result of decompression for the purposes of this invention is a sampled data signal corresponding to the desired audio. Audio CDs typically directly store the sampled audio data and thus require no decompression.

The next step is audio processing (block 204). System 100 will typically include audio data processing other than the time scale modification of this invention. This might include band equalization filtering, conversion between the various surround sound formats and the like. The exact mature of this other audio processing is not relevant to this invention and will not be discussed further.

The next step is time scale modification (block 205). This time scale modification changes the speed of play of the music data without changing its pitch. Flow chart 200 ends with data output (block 206). This data output supplies the processed data, such as a video signal having the desired format or an analog audio signal to an output device.

Digital systems such as illustrated in FIGS. 1 and 2 are generally characterized by a data flow-through. Data is read from a data source, processed and then supplied to an output device. The output must proceed in real-time for the video or music to appear seamless to the user. Other processes may be provided a non-real-time basis, but must be able to supply data required for the real time output. System designers have adopted many techniques to deal with such problems. If the computational requirements are stable and predictable, then it is possible to statically schedule tasks to meet the real-time requirements. In other cases where the computational requirements are variable or unpredictable, some sort of dynamic scheduling of tasks is more appropriate.

This invention involves such dynamic task scheduling via multi-threading. A program thread is a series of data processing instructions devoted to a task that is independent of other processes. Multi-threading can be carried out via multiple processors, such as microprocessor 121 and digital signal processor 123, or by a single general purpose data processor or a single digital signal processor. Individual program threads can be launched when needed and retired when no longer needed. A typical technique services separate threads on a static time-shared basis. Priority based systems that give preference to critical real-time processing are also known.

The following terminology is used in this application:

Node—A module, such as a MP3 decoder, that is described using a node object data structure which is run/scheduled based on availability of resources;

MSGQ—A messaging solution based on zero copy queing mechanism;

DATAQ—a buffer handling method using MSGQ as the basic structure;

OVLY—a resource for swapping program code in the same area of working memory;

SDRAM—memory access control to Synchronous Dynamic Random Access Memory; and

SWI—scheduling for the module threads.

In this invention, the operation of each module is split into the following six stages:

1. Receive any message from other modules in the system;

2. Process the message;

3. Get resources required for the module to function, such as accessing data in input and output buffers;

4. Perform the core processing required for the module;

5. Output the data generated by then module; and

6. Perform any swapping from external memory.

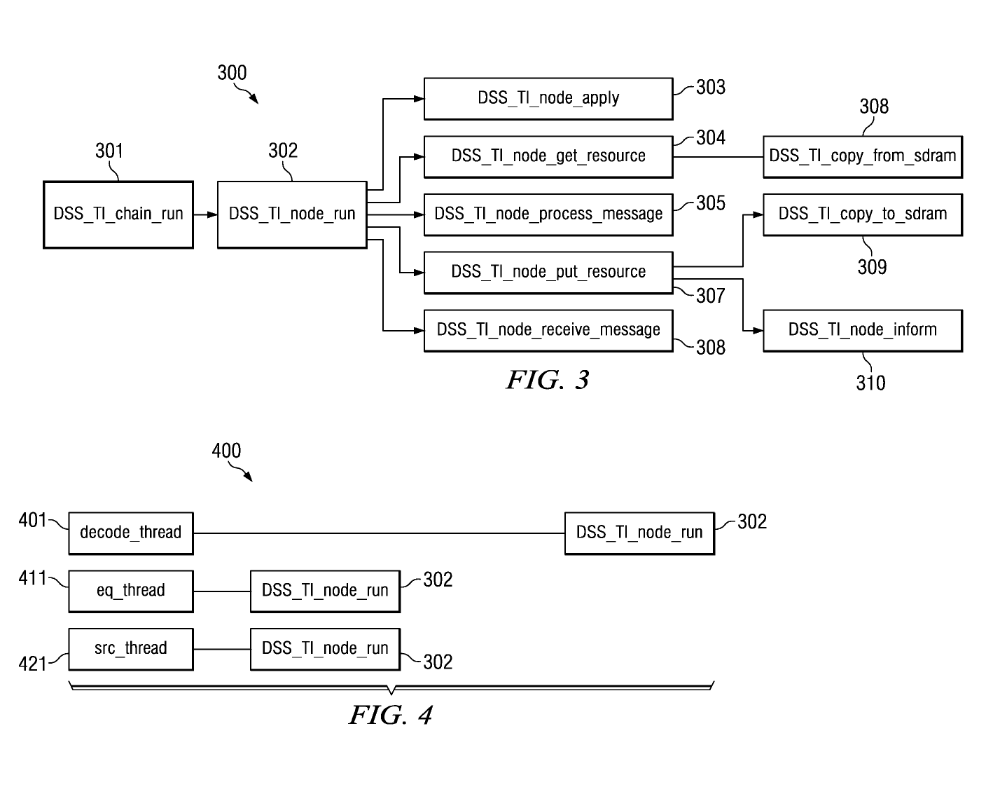

FIG. 3 illustrates the application process interfaces (API's) 300 of this invention. API 301 (DSS_TI_chain_run) enables initiating the thread control process. API 302 (DSS_I_node_run) enables launching the particular node module. API 308 (DSS_TI_node_receive_message) receives messages directed to that module. API 305 (DSS_TI_node_process message) enables processing of these received messages. API 304 (DSS_TI_node_get_resource) gets resources needed by this module. API 304 has a subsidiary API 308 (DSS_TI_copy_from_sdram) which permits control of the interface to memory (SDRAM) for needed data, constants or the like. API 303 (DSS_TI_node_apply) enables the data processing of the module. API 307 (DSS_TI_node_put_resource) enables output of resources generated by the module for use by other modules. API 307 has subsidiary APIs 309 and 310. API 309 (DSS_TI_copy_to_sram) enables data copying to specified memory locations in memory (SDRAM). API 310 (DSS_TI_node_inform) enables generation of messages to other nodes as a result of the output of the current node.

The framework of this invention is built by taking out the common operations in each of these steps. Each module is represented by a data structure. This data structure is an input to the framework whenever the module's thread runs. The framework does these 6 steps repetitively till a resource becomes unavailable, then it blocks. Other threads then arbitrate for a chance to run depending on their priority.

This invention includes several modules designed to provide services to algorithms executing within the system. Those services include:

Providing input/output data buffers (NODE+DATAQ);

Efficient scheduling of algorithm execution (NODE+SWI+MSGQ);

Performing algorithm swapping (NODE+OVLY);

Synchronizing control events (NODE+message registry);

Managing external memory buffers and DMA transfers (NODE+SDRAM); and

Providing extensible data management based on well known types (event triggers upon timestamps, etc.)

The program listing 1 illustrates the typical data structure of each module. The data structure contains all the data necessary for connecting a module to the external world, through the framework.

typedef struct_NODE_OBJ

{

MSGO_Handle pINMsgQ;
   /*!< Repository for messages coming to the node */
QUE_Handle* pInDataQArray;
   /*!< This is a pointer to an array of Que handles, one for each input. This is where all dataQ messages coming to the node are queued */
QUE_Handle pOutMsgQ;
   /*!< Repository for messages created by the node */
QUE_Handle pOutDateQ;
   /*!< Repository for data messages form the node. All data messages going out to other nodes are taken from this repository. Upon initialization, all output buffers owned by the node are placed in this repository */
Uinit15 numinputs;
   /*!< Number of inputs to the node */
DATAQ_HANDLE pCurrInDataQ;
   /*!< Pointer to an array of input dataQs currently being used. A null value indicates that there is no input buffer for that particular input channel. */
DATAQ_HANDLE pCurrOutDataQ;
   /*!< Pointer to the output buffer currently being used. A null value indicates that there is no output buffer to use. */
NODE_MSG_HANDLER_HANDLE pMsgHandler;
   /*!< A structure containing message handlers */
Ptr PCurrState
   /*!< A structure containing information about the state of the node */
Uint16 nodeType;
   /*!< The type of processing done by the node */
Uint32 totalOutputFramesPerCh;
   /*!< Number of buffers output from this node from initialization until current time */
struct_NODE_OBJ **pInputPairNodeArray;
   /*!< Nodes that are paired with this node on the input side. This is a pointer to an array of node handles. These nodes can either be within the current chain or outside it. */
struct_NODE_OBJ **pOutputPairNodeArray;
   /*!< Nodes that are paired with this node on the output side. This is a pointer to an array of node handles. These nodes can either be within the current chain or outside it. There is an assumption that each node has only one output. */
ABSTATUS (*pApplyFunc)( );
   /*!< Node specific Apply function */
ABSTATUS (*pInitFunc)( );
   /*!< Node specific Init (initialization) function */
      } NODE_OBJ, *NODE_HANDLE;

### Program Listing 1

FIG. 4 illustrates the run-time operation 400 of this invention. Once this functionality has been placed in the framework, each thread only needs to call the corresponding framework API to accomplish its task. Decode thread 401 (decode_thread) begins operation by calling the API 302 which enables initiation of the thread. Equalization thread 411 (eq_thread) and source thread 421 (src_thread) also begin by respective calls to API 302. During operation decode thread 401, equalization thread 411 and source thread 421 perform the six partitioned operations by calling corresponding APIs 303 to 310.

At least some of the problems of the prior art are solved by partitioning the data processing and message handling in an application thread. Once these functionalities are placed into a framework that performs these common activities, the application thread performs only the core processing required by the module. Thus, the application designer can concentrate on the specifics of the application and leave the rest to the framework.

The system architecture is controlled by the modules' data structures rather than by specific program code. Each node is paired to its neighbors through data structures. Such data structures can be redefined to change the system flow. Adding, removing or changing the location of a component becomes simpler than rewriting and removing an entire thread.

In the framework of this invention, the system flow is controlled by data structures. These data structures themselves can be generated from a minimal set of inputs. With a specified template that represents a header file, an input configuration can be used to generate required headed source files. A script written in any of the common scripting languages can be used to generate a headed source file that contains the initialized data structures which reflects the system architecture. These headed source files can then be included in the system build. Some most common scripting languages that can be used are Python, Javascript, etc. In this manner the data structures and the common functions and function prototypes are automatically generated for each node.

Because the framework is not dependent on any specific operating system (OS) related entities, the framework can be ported easily to any desired platform. In a typical embedded system development project, the software architecture has to be built before the silicon hardware completion date. This allows customer to develop and test their own modules before hardware is available. In such a case, the data structure based framework architecture can simulate the entire system function, on a software development platform such as IA/windows. This helps to debug common problems such as priority issues, deadlocks, data transfers and memory corruption problems so that these issues are no longer problems when hardware is first available.

This invention provides a “golden C” model of the system from which new versions can be derived just like development of individual algorithms. Before allocating effort for a new development, a new version can be derived from this “golden C” version and tested out on a PC platform. This new version can be ported easily to the target once proven. This enhances long term productivity.

This invention compares to the prior gStreamer as follows. Both gStreamer and this invention provide configurability of components, and data type and time awareness in their frameworks. Both gStreamer and this invention provide a clean application/framework split. Neither framework requires a framework change for a change in application. Both gStreamer and this invention implement data size matching within the framework and multiple frame decode support. Both gstreamer and this invention enable zero copy message passing and support non-sequential decode flows. Both gstreamer and this invention permit operation interruption during cross fade operations. This invention is advantageous over gstreamer because it supports reuse of common code across applications and permits script based code/header file generation for nodes. This invention is advantageous over gstreamer because it supports data type overload through a DataQ to SDRAMQ sequence. The buffer ownership and the number of buffer messages is similar between gstream and this invention except that this invention enables both buffer full and buffer empty messages while gstream generates only buffer full messages. This invention is advantageous over gstreamer because this invention supports explicit run-time code swapping while this feature in gstream is operating system dependent. This invention is advantageous over gstreamer because it provides messaging independent of the framework and messaging support for multiple thread types. Additionally, this invention supports processor independent and operating system independent messaging. Lastly, this invention requires a smaller memory footprint than gstream.

What is claimed is:

1. A computer implemented method of multi-threaded data processing operation comprising the steps of:
generating at least one data processing module performing a data processing function;
partitioning each data processing module into at least five sub-modules including (1) receiving messages, (2) processing received messages, (3) getting resources for module function, (4) performing a core data processing operation of the module and (5) outputting resources generated by the module in the core data processing operation sub-module; and
launching and retiring modules and the corresponding sub-modules in a multi-threaded environment.

2. The method of claim 1, wherein:
said step of partitioning each data processing module further includes partitioning at least one data processing module into a sub-module performing data swapping in an external memory.

3. The method of claim 1, wherein:
said step of launching modules and sub-modules includes
generating an application process interface (API) for launching a module and for launching each of said five sub-modules,
launching a module by invoking said API for launching a module, and
launching a sub-module by invoking said API for said launching said corresponding sub-module.

4. The method of claim 1, wherein:
said step of partitioning a module into sub-modules includes sharing a sub-module among a plurality of modules.

5. The method of claim 4, wherein:
said shared sub-module includes said receiving messages sub-module.

6. The method of claim 4, wherein:
said shared sub-module includes said processing received messages sub-module.

7. The method of claim 4, wherein:
said shared sub-module includes said getting resources for module function sub-module.

8. The method of claim 4, wherein:
said shared sub-module includes said outputting resources generated by the module sub-module.
